(19) United States
(12) Patent Application Publication
(10) Pub. No.: US 2026/0229930 A1
(43) Pub. Date: Aug. 6, 2026

(54) STATOR CORE

(71) Applicants: TOYOTA JIDOSHA KABUSHIKI KAISHA, Toyota-shi (JP); MITSUI HIGH-TEC, INC., Kitakyushu-shi (JP)

(72) Inventors: Fumiaki YAMATO, Okazaki-shi (JP); Junichi DEGUCHI, Toyota-shi (JP); Keiichi KANESHIGE, Seto-shi (JP); Syohei YOSHISAKO, Kitakyushu-shi (JP)

(73) Assignees: TOYOTA JIDOSHA KABUSHIKI KAISHA, Toyota-shi (JP); MITSUI HIGH-TEC, INC., Kitakyushu-shi (JP)

(21) Appl. No.: 19/405,874

(22) Filed: Dec. 2, 2025

(30) Foreign Application Priority Data
Jan. 21, 2025 (JP) 2025-008399

(51) Int. Cl. H02K 1/14

(52) U.S. Cl. CPC H02K 1/148

(57) ABSTRACT

A stator core includes a plurality of split cores arranged in a circumferential direction of the stator core so as to form an annular shape. A pair of adjacent split cores, among the plurality of split cores, includes a pair of end surfaces facing each other with a clearance therebetween in the circumferential direction of the stator core, and a magnetic resin filled in the clearance.

### CROSS-REFERENCE TO RELATED APPLICATION

This application is based upon and claims the benefit of priority of the prior Japanese Patent Application No. 2025-008399, filed on January 21, 2025, the entire contents of which are incorporated herein by reference.

### TECHNICAL FIELD

The present disclosure relates to a stator core.

### BACKGROUND

As for a stator core of a rotary electric machine, for example, Japanese Patent Application Publication No. 2011-259661 describes an annular stator core having a plurality of split cores. The split cores are arranged in an annular shape adjacent to each other in the circumferential direction of the stator core. In order to fix the split cores to each other, an annular ring member is attached to the outer circumferential surface of the stator core by shrink fitting or press fitting.

When the ring member is shrink-fitted or press-fitted to the split cores, distortion or displacement occurs in the split cores, and thus magnetic fluxes are excessively concentrated on a part of the stator core. Therefore, there is a possibility that the iron loss of the stator core increases. For example, in a rotary electric machine mounted on an electric vehicle or a hybrid vehicle, when the iron loss of the stator core increases, the electric power efficiency during traveling might deteriorate.

### SUMMARY

It is therefore an object of the present disclosure to provide a stator core capable of reducing iron loss.

The above object is achieved by a stator core includes a plurality of split cores arranged in a circumferential direction of the stator core so as to form an annular shape, wherein a pair of adjacent split cores, among the plurality of split cores, including: a pair of end surfaces facing each other with a clearance therebetween in the circumferential direction of the stator core; and a magnetic resin filled in the clearance.

In the stator core described above, the pair of adjacent split cores may include a pair of groove portions respectively provided in the pair of end surfaces so as to face each other, and the magnetic resin may be filled in the clearance and the pair of groove portions.

In the stator core described above, the pair of groove portions may extend in an axial direction of the annular shape, and each width of the pair of groove portions may narrow toward the pair of end surfaces.

In the stator core described above, each of the pair of end surfaces may be a flat surface.

In the stator core described above, each of the pair of end surfaces may be a bent surface bent in a direction from an inner edge of the stator core toward an outer edge of the stator core.

In the stator core described above, the pair of groove portions may be provided at a position closer to an outer edge of the stator core than to an inner edge of the stator core.

### BRIEF DESCRIPTION OF THE DRAWINGS

FIG. 1 is a cross-sectional view schematically illustrating a rotary electric machine;

FIG. 2 is a perspective view illustrating a stator core;

FIG. 3 is a plan view illustrating a vicinity of a boundary of split cores in a front view along an axial direction;

FIG. 4A is a cross-sectional view of the vicinity of the boundary between the split cores along the line A-A in FIG. 3, and FIG. 4B is a cross-sectional view of the vicinity of the boundary between the split cores along the line B-B in FIG. 3;

FIG. 5 is a view illustrating a cross section of a connection portion of a split core of a comparative example; and

FIG. 6 is a view illustrating another example of the stator core.

### DETAILED DESCRIPTION

### Configuration of Rotary Electrical Machine

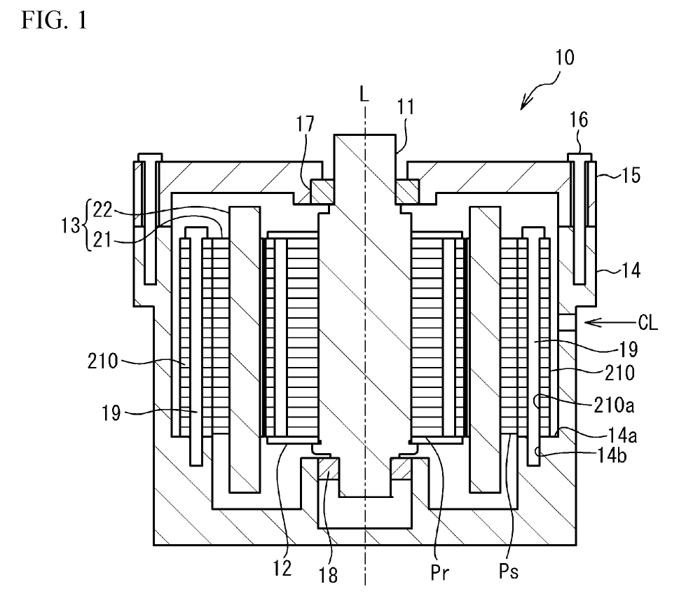

FIG. 1 is a cross-sectional view schematically illustrating a rotary electric machine 10. The rotary electric machine 10 is a permanent magnet synchronous polyphase AC motor having an inner rotor structure (inner rotation structure). The rotary electric machine 10 is used as, for example, a drive source of a hybrid vehicle or an electric vehicle.

FIG. 1 illustrates a vertical cross section along a rotation shaft 11 of the rotary electric machine 10. In the following description, the direction in which the rotation shaft 11 extends is referred to as an axial direction L. Further, a direction extending radially from the rotation shaft 11 and orthogonal to the rotation shaft 11 is referred to as a radial direction, and a direction extending circumferentially about the rotation shaft 11 is referred to as a circumferential direction. The axial direction L is an example of the axial direction of the annular shape, and the circumferential direction is an example of the circumferential direction of the annular shape.

The rotary electric machine 10 includes a rotor 12, a stator 13, a housing 14, and a cover 15. The rotor 12 is fixed to the rotating shaft 11. The stator 13 has a substantially cylindrical shape and surrounds the rotor 12. The housing 14 accommodates the rotor 12 and the stator 13. The cover 15 is fixed to an end side of the housing 14 in the axial direction L.

The rotor 12 and the stator 13 are coaxially arranged in a state of facing each other in the radial direction. The rotor 12 and the stator 13 have a laminated structure in which magnetic steel sheets Pr and Ps of magnetic bodies are respectively laminated in the axial direction L. Each of the electromagnetic steel sheets Pr and Ps is formed by punching out a sheet-shaped electromagnetic steel sheet for manufacturing by pressing with a predetermined mold.

The housing 14 is a bottomed cylindrical member that is open on an end side in the axial direction L. The cover 15 is attached to the open end of the housing 14 by a plurality of bolts 16. The housing 14 and the cover 15 are provided with bearings 17 and 18. The bearings 17 and 18 rotatably support the rotating shaft 11 and the rotor 12.

The housing 14 is provided with a pedestal portion 14a for fixing the stator 13. The pedestal portion 14a includes screw holes 14b extending in the axial direction L. The stator 13 has a stator core 21 and windings 22. The stator core 21 includes fixing portions 210 for fixing the stator core 21 to the pedestal portion 14a. A fixing bolt 19 is inserted into an insertion hole 210a of the fixing portion 210 and is screwed into the screw hole 14b. As a result, the stator core 21 is fixed to the housing 14 so as to abut against the end surface of the pedestal portion 14a in the axial direction L.

The windings 22 are wound around the stator core 21. The windings 22 includes a U-phase winding, a V-phase winding, and a W-phase winding. An end of the winding of each phase is connected to a power line bus bar (not illustrated) of each phase, and the other end is connected to a neutral line bus bar (not illustrated).

The rotary electric machine 10 includes a cooling structure using a coolant such as a lubricant in the housing 14. For example, a coolant CL is supplied from the upper side of the housing 14, and the coolant CL flows along the outer peripheral surface of the stator 13, thereby cooling the stator 13.

### Configuration of Stator Core

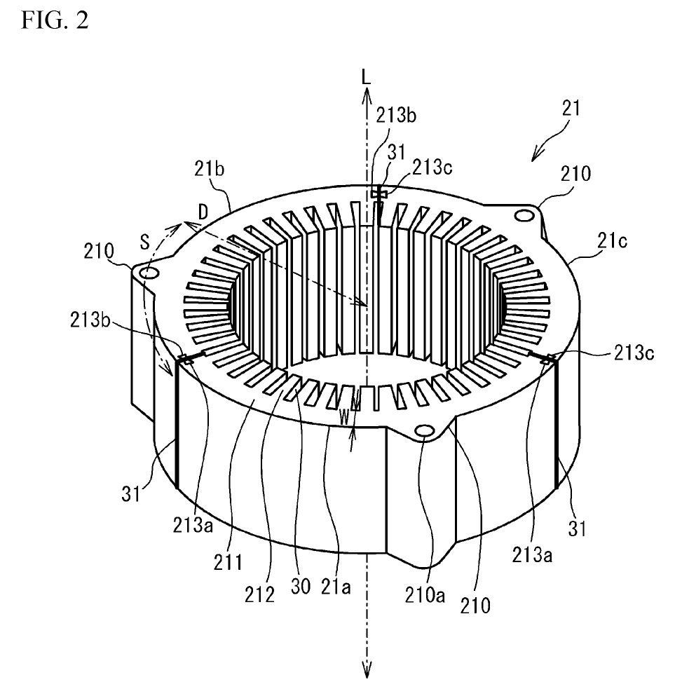

FIG. 2 is a perspective view illustrating the stator core 21. The stator core 21 has, for example, an annular shape. The stator core 21 includes a ring-shaped yoke 211 and a plurality of teeth 212 each having a substantially quadrangular prism shape. The plurality of teeth 212 protrude from an inner edge of the yoke 211 in the radial direction D. The teeth 212 are provided on the inner circumferential surface of the yoke 211 at regular intervals. The stator core 21 is not limited to the annular shape, and may have another annular shape.

A slot 30 is provided between a pair of teeth 212 adjacent to each other. The winding 22 is wound around each of the teeth 212 through the slots 30 for each phase. Therefore, when the winding 22 is energized, magnetic fluxes are generated in the stator core 21. The magnetic fluxes change according to the rotation of the rotor 12.

The yoke 211 has a substantially constant width W in the radial direction D. As an example, the three fixing portions 210 are provided at regular intervals on the outer circumferential surface of the yoke 211. The yoke 211 is formed integrally with the fixing portions 210 and the teeth 212, but the fixing portion 210 is not limited thereto, and may be formed separately from the yoke 211 and may be joined to the yoke 211.

The stator core 21 is configured by, for example, connecting three split cores 21a to 21c arranged in the circumferential direction S. The split cores 21a to 21c each correspond to a region of one third of the entire annular shape of the stator core 21. That is, the split cores 21a to 21c correspond to a fan-shaped arc region having a central angle of 120 degrees when viewed from the axial direction L of the central shaft. The fixing portions 210 are provided on the split cores 21a to 21c, respectively. The number of the split cores 21a to 21c is not limited to three, and may be two or four or more.

Clearances 31 are provided between the split cores 21a and 21b adjacent to each other, between the split cores 21b and 21c adjacent to each other, and between the spit cores 21c and 21a adjacent to each other. The clearance 31 are not provided in the teeth 212, but is provided in the yoke 211 so as to extend from the slots 30 in the radial direction D. This makes it possible to reduce an area of an end surface of the boundary region of each of the split cores 21a to 21c, as compared with the case where the clearance 31 are provided over the teeth 212 and the yoke 211. The clearance 31 are not limited to this, and may be provided over the teeth 212 and the yoke 211.

The split cores 21a to 21c each include two groove portions 213a to 213c each connected to the clearance 31. The groove portions 213a to 213c of the split cores 21a to 21c adjacent to each other face each other with the clearance 31 interposed therebetween, and the clearances 31 and the groove portions 213a to 213c are filled with magnetic resins. Accordingly, the split cores 21a to 21c are connected to each other without providing the above-described ring member on the outer periphery of the split cores 21a to 21c, and magnetic fluxes are favorably passed between the split cores 21a to 21c. Therefore, distortion and misalignment of the split cores 21a to 21c are reduced more than in the case of using the ring member.

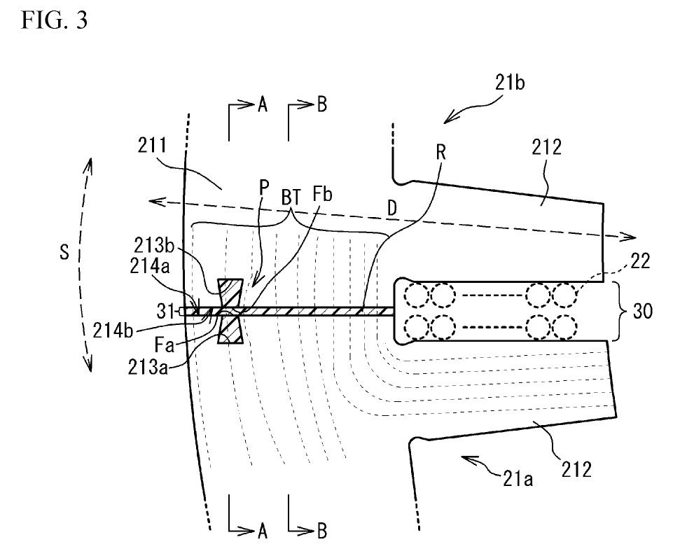

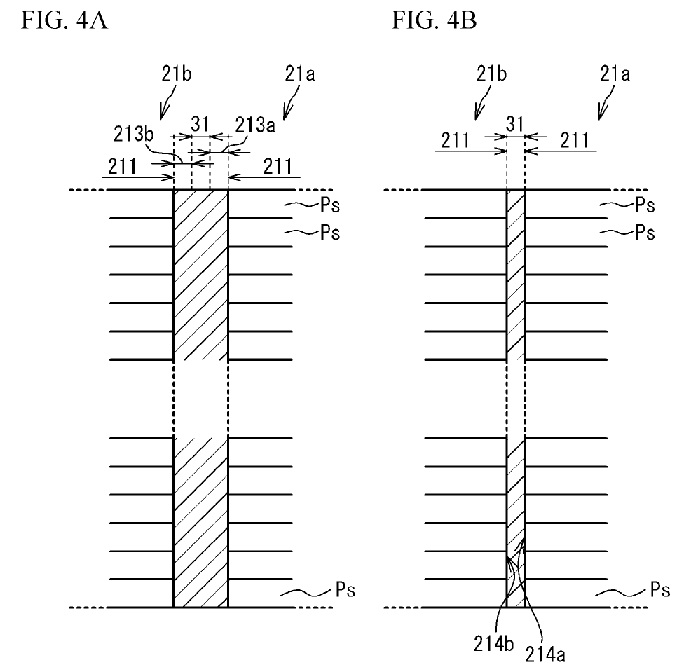

FIG. 3 is a plan view illustrating the vicinity of the boundary between the split cores 21a and 21b in a front view along the axial direction L. Further, FIG. 4A is a cross-sectional view of the vicinity of the boundary between the split cores 21a and 21b along the line A-A of FIG. 3, and FIG. 4A is a cross-sectional view of the vicinity of the boundary between the split cores 21a and 21b along the line B-B of FIG. 3. In FIGS. 3, 4A and 4B, the same symbols are given to the same components as those in FIG. 2, and the description thereof will be omitted.

The split cores 21a and 21b are adjacent to each other via the clearance 31. An end surface 214a of the split core 21a and an end surface 214b of the split core 21b face each other via the clearance 31 in the circumferential direction S. As illustrated in the FIG. 4A, the clearance 31 is provided over the entire layer of the electromagnetic steel sheets Ps along the axial direction L between the end surfaces 214a and 214b. The width of the clearance 31 in the circumferential direction S is not limited. The clearance 31 is filled with a magnetic resin R. The magnetic resin R in the clearance 31 functions as a buffer material between the split cores 21a and 21b.

Therefore, the split cores 21a and 21bs are not only coupled to each other by the magnetic resin R, but also external force acting between the split cores 21a and 21bs is alleviated as compared with a case where the split cores 21a and 21bs are directly connected to each other without the clearance 31. For example, even if external force acts on the split cores 21a and 21b due to errors in the mounting positions of the split cores 21a and 21b with respect to the pedestal portion 14a, the magnetic resin R in the clearance 31 is plastically deformed, and thus the stresses acting on the split cores 21a and 21b is reduced. Therefore, distortion and misalignment of the split cores 21a and 21b are suppressed.

Further, the groove portion 213a is provided in the end surface 214a of the split core 21a, and the groove portion 213b is provided in the end surface 214b of the split core 21b. The magnetic resin R is filled in the groove portions 213a and 213b continuously with the magnetic resin R in the clearance 31. When the split cores 21a and 21b are viewed from the front along the axial direction L, the groove portions 213a and 213b each have a substantially trapezoidal shape in which one side of the shorter one of the upper base and the lower base is opened. The groove portions 213a and 213b are formed on the end surfaces 214a and 214b, respectively, so as to face each other with the clearance 31 interposed therebetween. Specifically, an open surface Fa of the groove portion 213a and an open surface Fb of the groove portion 213b face each other with the clearance 31 interposed therebetween.

The widths of the groove portions 213a and 213b are respectively narrowed toward the end surfaces 214a and 214b, that is, toward the open faces Fa and Fb of the groove portions, and the whole shape of the groove portions 213a and 213b and the clearance 31 therebetween is substantially a ribbon shape. As a result, the magnetic resin R in the groove portions 213a and 213b and the clearance 31 functions as a substantially ribbon-shaped connecting means that connects the split cores 21a and 21b to each other.

As illustrated in FIG. 4A, the groove portions 213a and 213b are respectively provided on the end surfaces 214a and 214b over the entire layer of the electromagnetic steel sheet Ps along the axial direction L. Since the groove portions 213a and 213b and the clearance 31 therebetween are filled with the magnetic resin R, the split cores 21a and 21b are connected to each other by the magnetic resin R having a substantially trapezoidal shape in the groove portions 213a and 213b. Since the widths of the magnetic resin R in the groove portions 213a and 213b become narrower toward the clearance 31, even when an external force acts in the circumferential direction S so that the split cores 21a and 21b are separated from each other, the magnetic resin R are less likely to be separated from the groove portions 213a and 213b, and the connection between the split cores 21a and 21b is maintained. The shape of the groove portions 213a and 213b is not limited to the above-described shape, and may be another shape such as a rectangular shape. Even in this case, the magnetic resin R in the groove portions 213a and 213b cause a stronger coupling force to act between the split cores 21a and 21b than in the case where the groove portions 213a and 213b are not provided. Further, since the magnetic resin R is filled in the entire clearance 31, the connection between the split cores 21a and 21b is maintained.

In this way, the split cores 21a and 21b are connected to each other by the magnetic resin R in the groove portions 213a and 213b and the clearance 31 without providing the above-described ring member. Therefore, distortion and misalignment of the split cores 21a to 21c are reduced, and iron loss of the stator core 21 is reduced.

Further, since the magnetic resin R has a higher magnetic permeability than a non-magnetic resin, magnetic fluxes BT generated by the energization of the winding 22 in the slot 30 are passed well. The magnetic fluxes BT pass through the rotor 12 and are generated from the teeth 212 along the circumferential direction S of the yoke 211.

Further, since the conductivity of the magnetic resin R is lower than the conductivity of the electromagnetic steel sheet Ps, the current flowing between the split cores 21a and 21b is suppressed. Thus, an eddy current between the split cores 21a and 21b is suppressed, and therefore, the hysteresis loss is reduced.

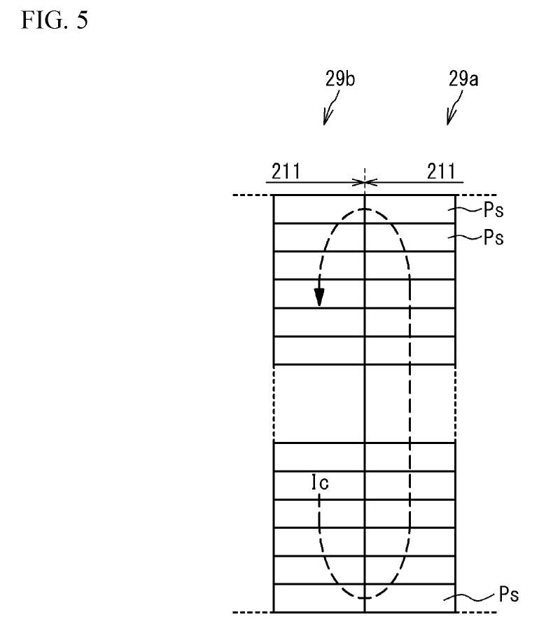

FIG. 5 is a view illustrating a cross section of a connection portion between split cores 29a and 29b of a comparative example. In FIG. 5, the same symbols are given to the configurations common to those in FIG. 4A and the drawing 4B, and the description thereof will be omitted. The split cores 29a and 29b of the comparative example do not include the groove portions 213a and 213b and the clearance 31, and are connected without the magnetic resin R interposed therebetween. Therefore, the electromagnetic steel sheets Ps of the split cores 29a and 29b are in direct contact with each other in the circumferential direction S.

Therefore, when the magnetic fluxes BT of the stator core 21 change with the rotation of the rotor 12, an eddy current Ic is generated in the electromagnetic steel sheets Ps at the split cores 29a and 29b so as to prevent the fluxes from changing due to electromagnetic induction, and hysteresis loss increases. However, since the magnetic resin R is present between the split cores 21a and 21b in the present embodiment, the generation of the eddy current Ic is suppressed, and the hysteresis loss of the stator core 21 is reduced.

The magnetic resin R is produced by adding a magnetic material to, for example, a thermosetting resin or a thermoplastic resin. The thermosetting resin or the thermoplastic resin preferably has appropriate strength and adhesiveness. Examples of the magnetic material include, but are not limited to, a neodymium-based material, an amorphous-based material, and a samarium-based material. Alternatively, a filler of a ferromagnetic metal such as iron may be included in the resin as a magnetic material.

A part of the magnetic resin R filling the groove portions 213a and 213b has a size larger than a part of the magnetic resin R filling the clearance 31 in the circumferential direction S of the stator core 21. Therefore, the magnetic fluxes BT passes through the magnetic resin R in the clearance 31 more easily than the magnetic resin R in the groove portions 213a and 213b, and distortion occurs in the magnetic fluxes BT in the vicinity of the groove portions 213a and 213b (see reference sign P).

Therefore, the groove portions 213a and 213b are provided at positions closer to the outer edge of the stator core 21 than to the inner edge of the stator core 21 in the radial direction D of the stator core 21. Accordingly, the groove portions 213a and 213b are provided at positions where the magnetic flux densities are low, and thus the influence of the magnetic resin R in the groove portions 213a and 213b on the magnetic fluxes BT is reduced. It is preferable that the groove portions 213a and 213b are provided radially outside the center of the width W of the yoke 211 because the influence of the magnetic fluxes BT is further reduced.

The magnetic flux densities of the magnetic field generated from the winding 22 decreases toward the outer edge in the radial direction D of the stator core 21, and increases toward the inner edge. If the groove portions 213a and 213b and the clearance 31 are filled with the non-magnetic resin, the magnetic fluxes BT are less likely to pass through the split cores 21a and 21b, and thus the rotary electric machine 10 might not function.

Further, since the end surfaces 214a and 214b are flat surfaces, stresses between the end surfaces 214a and 214b are reduced when an external force acts in the radial direction D of the stator core 21, as compared with a case where the end surfaces 214a and 214b are bent in the radial direction D of the stator core 21. Therefore, the distortion of the split cores 29a and 29b is suppressed. The end surfaces 214a and 214b are, for example, flat surfaces extending in the radial direction D of the stator core 21, but are not limited thereto, and may be flat surfaces inclined with respect to the radial direction D. Further, the end surfaces 214a and 214b may be bent surfaces.

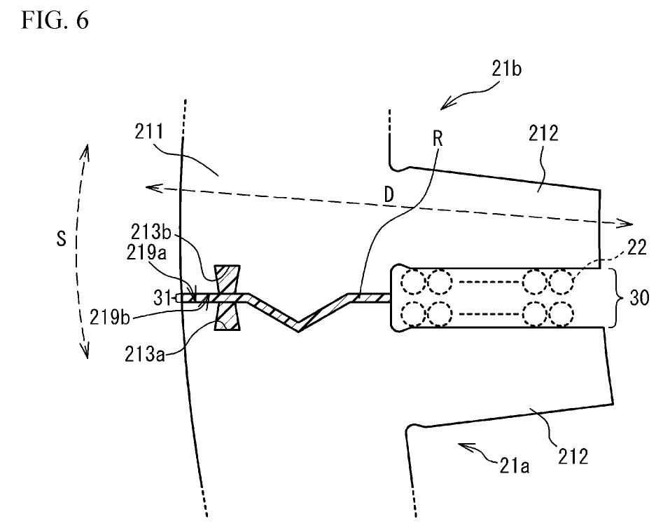

FIG. 6 is a view illustrating another example of the stator core 21. In FIG. 6, the same reference numerals are given to the same components as those in FIG. 3, and the description thereof will be omitted. In the present example, the split cores 21a and 21b have end surfaces 219a and 219b of bent surfaces instead of the end surfaces 214a and 214b of flat surfaces. The end surface 219a and the end surface 219b are bent at, for example, three positions in the radial direction D from the inner edge to the outer edge of the stator core 21. Therefore, the end surfaces 219a and 219b are combined with each other with the magnetic resin R interposed therebetween, and thus the positioning of the split cores 21a and 21b in the radial direction D is easy as compared with a case where the end surfaces 214a and 214b are flat surfaces. The number and shape of the bent portions are not limited.

Although the configuration near the boundary between the split cores 21a and 21b has been illustrated above, the configuration near the boundary between the split cores 21a and 21c and the configuration near the boundary between the split cores 21b and 21c are the same as the above. Therefore, the stator core 21 connects the split cores 21a to 21c without requiring a ring member.

In this example, the split cores 21a to 21c include the end surfaces 214a to 214c and 219a and 219b, the clearances 31, and the groove portions 213a and 213b that are common to all the electromagnetic steel sheets Ps, but the present disclosure is not limited thereto. The split cores 21a to 21c may include, for example, for each layer of a predetermined number of the electromagnetic steel sheets Ps adjacent to each other in the axial direction L, individual end surfaces 214a to 214c and 219a and 219b, the clearances 31, and the groove portions 213a and 213b that are located at different positions in the circumferential direction S of the stator core 21. The number of the groove portions 213a and 213b is not limited. Further, although the groove portions 213a and 213c are provided in the end surfaces 214a to 214c, 219a, and 219b of the split cores 21a to 21c in the present example, the groove portions 213a and 213b are not necessarily required because the magnetic resin R in the clearance 31 couple the split cores 21a and 21b as described above.

Although some embodiments of the present disclosure have been described in detail, the present disclosure is not limited to the specific embodiments but may be varied or changed within the scope of the present disclosure as claimed.

What is claimed is:

1. A stator core comprising
a plurality of split cores arranged in a circumferential direction of the stator core so as to form an annular shape,
wherein
a pair of adjacent split cores, among the plurality of split cores, including:
a pair of end surfaces facing each other with a clearance therebetween in the circumferential direction of the stator core; and
a magnetic resin filled in the clearance.

2. The stator core according to claim 1, wherein
the pair of adjacent split cores includes a pair of groove portions respectively provided in the pair of end surfaces so as to face each other, and
the magnetic resin is filled in the clearance and the pair of groove portions.

3. The stator core according to claim 2, wherein
the pair of groove portions extends in an axial direction of the annular shape, and
each width of the pair of groove portions narrows toward the pair of end surfaces.

4. The stator core according to claim 1, wherein each of the pair of end surfaces is a flat surface.

5. The stator core according to claim 1, wherein each of the pair of end surfaces is a bent surface bent in a direction from an inner edge of the stator core toward an outer edge of the stator core.

6. The stator core according to claim 2, wherein the pair of groove portions is provided at a position closer to an outer edge of the stator core than to an inner edge of the stator core.
